(19) United States
(12) Patent Application Publication
(10) Pub. No.: US 2024/0318722 A1
(43) Pub. Date: Sep. 26, 2024

(54) RUBBER SEALING GASKET WITH EXCELLENT COMPRESSION PERFORMANCE AND LOW-TEMPERATURE PERFORMANCE, AND PREPARATION METHOD AND USE THEREOF

(71) Applicant: XUZHOU COLLEGE OF INDUSTRIAL TECHNOLOGY, Jiangsu (CN)

(72) Inventors: Yunhui XU, Jiangsu (CN); Shuangyuan XU, Jiangsu (CN); Tongyu ZHANG, Jiangsu (CN); Yating XU, Jiangsu (CN); Jiayao LI, Jiangsu (CN); Zefeng SHAO, Jiangsu (CN); Zaixue WANG, Jiangsu (CN); Yanan ZANG, Jiangsu (CN); Houluo CONG, Jiangsu (CN); Dazhi ZHANG, Jiangsu (CN); Peipei LI, Jiangsu (CN); Lianxiang ZHOU, Jiangsu (CN)

(73) Assignee: XUZHOU COLLEGE OF INDUSTRIAL TECHNOLOGY, Jiangsu (CN)

(21) Appl. No.: 18/613,029

(22) Filed: Mar. 21, 2024

(30) Foreign Application Priority Data
Mar. 22, 2023 (CN) 202310284301.0

(51) Int. Cl. F16J 15/02; C08L 15/00

(52) U.S. Cl. CPC F16J 15/022; C08L 15/005; C08L 2666/02; C08L 2666/55; C08L 2666/68; C08L 2666/72

(57) ABSTRACT

The present disclosure belongs to the technical field of polymer rubber composites, and specifically relates to a rubber sealing gasket with excellent compression performance and low-temperature performance, and a preparation method and use thereof. The rubber sealing gasket is prepared from the following raw materials in parts by mass: a hydrogenated nitrile butadiene rubber (HNBR): 100 parts; a processing aid: 12.3 parts to 13.7 parts; a reinforcing filler: 45 parts to 65 parts; a vulcanizing agent: 4.8 parts to 5.2 parts; and a co-crosslinking agent: 4.8 parts to 5.2 parts. The rubber sealing gasket prepared by the present disclosure has excellent compression performance and low-temperature performance, meets the performance requirements of rubber sealing gaskets for automobile air-conditioning systems, and can be used in sealing components of automobile air-conditioning systems.

### CROSS-REFERENCE TO RELATED APPLICATION

This application claims the priority benefit of China application serial no. 202310284301.0, filed on Mar. 22, 2023. The entirety of the above-mentioned patent application is hereby incorporated by reference herein and made a part of this specification.

### TECHNICAL FIELD

The present disclosure belongs to the technical field of polymer rubber composites, and specifically relates to a rubber sealing gasket with excellent compression performance and low-temperature performance, and a preparation method and use thereof.

### BACKGROUND

Rubber sealing gaskets for automobile air-conditioning systems play an important sealing role in air-conditioning systems, and need to have specified mechanical and aging properties and excellent compression and low-temperature performance.

The existing sealing gaskets for automobile air-conditioning systems have a compression set rate of 35% to 68% and exhibit poor compression performance (when a type A sample is tested at 125° C.±3° C. for 72 h to 2 h, a compression rate is 25%), which is difficult to meet the requirements of sealing performance. In addition, the existing sealing gaskets for automobile air-conditioning systems have poor low-temperature performance, and will crack early when used at a low temperature.

### SUMMARY

In order to solve the above problems, the present disclosure provides a rubber sealing gasket with excellent compression performance and low-temperature performance, and a preparation method and use thereof. The rubber sealing gasket of the present disclosure has excellent compression performance and low-temperature performance, and can meet the requirements of applications in sealing components of automobile air-conditioning systems.

A first objective of the present disclosure is to provide a rubber sealing gasket with excellent compression performance and low-temperature performance, where the rubber sealing gasket is prepared from the following raw materials in parts by mass:

| | |
|---|---|
| hydrogenated nitrile butadiene | 100 parts; |
| rubber (HNBR) | |
| processing aid | 12.3 parts to 13.7 parts; |
| reinforcing filler | 45 parts to 65 parts; |
| vulcanizing agent | 4.8 parts to 5.2 parts; and |
| co-crosslinking agent | 4.8 parts to 5.2 parts. |

Preferably, the HNBR is HNBR 2020L with an acrylonitrile content of 36% to 38%, a Mooney viscosity of 50 to 65, a specific gravity of 0.94 g/cm³ to 0.96 g/cm³, a hydrogenation rate of 90% to 91%, and an iodine index of 27 to 28.

Preferably, the processing aid is a mixture of an activating agent, an anti-aging agent, and a plasticizing agent, where the activating agent includes zinc oxide and stearic acid, the anti-aging agent includes anti-aging agents MB and RD, and the plasticizing agent is TP-95.

Preferably, the reinforcing filler is a mixture of carbon black N220 and carbon black N990.

Preferably, the vulcanizing agent is dicumyl peroxide (DCP), and the co-crosslinking agent is triallyl isocyanurate (TAIC).

Preferably, based on 100 parts by mass of the HNBR, the stearic acid is used in 0.9 parts to 1.1 parts, the zinc oxide is used in 4.8 parts to 5.2 parts, the anti-aging agent MB is used in 0.9 parts to 1.1 parts, the anti-aging agent RD is used in 0.9 parts to 1.1 parts, the plasticizing agent TP-95 is used in 4.8 parts to 5.2 parts, the carbon black N220 is used in 20 parts to 30 parts, the carbon black N990 is used in 25 parts to 35 parts, the DCP is used in 4.8 parts to 5.2 parts, and the TAIC is used in 4.8 parts to 5.2 parts.

A second objective of the present disclosure is to provide a preparation method of the rubber sealing gasket with excellent compression performance and low-temperature performance, including the following steps:
S1. subjecting the HNBR, the processing aid, and the reinforcing filler to first internal mixing to obtain a masterbatch;
S2. subjecting the masterbatch obtained in the S1 to second internal mixing with the vulcanizing agent and the co-crosslinking agent to obtain a HNBR mixture; and
S3. vulcanizing the HNBR mixture obtained in the S2 twice to obtain the rubber sealing gasket with excellent compression performance and low-temperature performance.

Preferably, in the S3, the vulcanizing is conducted twice as follows: conducting a first vulcanization for 12 min to 22 min at a first temperature of 170° C. to 175° C. and a pressure of 10 MPa to 20 MPa; and conducting a second vulcanization for 3 h to 5 h at a second temperature of 150° C. to 155° C.

Preferably, the first vulcanization is conducted by a plate vulcanizing machine or an injection vulcanizing machine, and the second vulcanization is conducted by an atmospheric pressure layered vulcanization process, an atmospheric pressure hot-air vulcanization process, or an atmospheric pressure salt-bath hot vulcanization process.

A third objective of the present disclosure is to provide a use of the rubber sealing gasket with excellent compression performance and low-temperature performance in a sealing component of an automobile air-conditioning system.

Compared with the prior art, the present disclosure has the following beneficial effects:

The present disclosure adopts a HNBR with a high acrylonitrile content, and the HNBR has excellent compression set performance, cold resistance, heat resistance, oil resistance, and tear resistance and a high strength. In the present disclosure, a carboxyl-free peroxide vulcanization process is adopted to provide a relatively high decomposition temperature, and vulcanization is conducted at 170° C. to 175° C. to improve a vulcanization efficiency. The co-crosslinking agent TAIC is non-flammable, non-explosive, and non-harmful to an environment, has stable chemical properties, and can be stored under shade and dark conditions for a long time. Thus, the co-crosslinking agent can be transported and stored as a non-dangerous good. In addition, the use of TAIC as a co-crosslinking agent can significantly improve a crosslinking density, shorten a vulcanization time, and improve mechanical properties, heat resistance, and compression performance of a product.

The reinforcing filler of the present disclosure is a combination of ultra-wear-resistant furnace black N220 and medium-particle thermal-cracking spray carbon black N990, which can ensure that the rubber composite has excellent mechanical properties and a small deformation, reducing a compression set rate. The plasticizing agent of the present disclosure is an eco-friendly plasticizing agent TP-95, which has low volatility and prominent cold and heat resistance, does not include carcinogens, and can reach the ROHS standard. The prepared rubber sealing gasket meets the performance requirements of rubber sealing gaskets for automobile air-conditioning systems, and can be used in sealing components of automobile air-conditioning systems.

### BRIEF DESCRIPTION OF THE DRAWINGS

FIG. 1 shows low-temperature performance of the rubber sealing gasket prepared in Example 1 of the present disclosure;

FIG. 2 shows a microstructure of the rubber sealing gasket prepared in Example 1 of the present disclosure;

FIG. 3 shows thermogravimetric analysis (TGA) results of the rubber sealing gasket prepared in Example 1 of the present disclosure; and

FIG. 4 shows differential scanning calorimetry (DSC) results of the rubber sealing gasket prepared in Example 1 of the present disclosure.

### DETAILED DESCRIPTION OF THE EMBODIMENTS

The present disclosure is described in detail below in conjunction with specific embodiments, but it should be understood that the protection scope of the present disclosure is not limited by the specific embodiments. In the following examples, a test method for which specific conditions are not specified is usually conducted according to conventional conditions, and experimental materials not detailed are commercially available, where steps of the test method are not described in detail because no invention point is not involved.

### Example 1

A rubber sealing gasket with excellent compression performance and low-temperature performance was provided, and the rubber sealing gasket was prepared from the following raw materials in parts by mass:

HNBR 2020L: 100 parts; stearic acid: 1.0 part; TAIC: 5.0 parts; vulcanizing agent DCP: 5.0 parts; zinc oxide: 5.0 parts; anti-aging agent MB: 1.0 part; anti-aging agent RD: 1.0 part; carbon black N220: 25 parts; spray carbon black N990: 30 parts; and eco-friendly plasticizing agent TP-95: 5.0 parts.

The HNBR 2020L had an acrylonitrile content of 37%, a Mooney viscosity of 60, a specific gravity of 0.95 g/cm³, a hydrogenation rate of 90%, and an iodine index of 28.

A preparation method of the rubber sealing gasket with excellent compression performance and low-temperature performance was also provided, including the following steps:
S1. The raw materials were weighed according to the proportions. An internal mixer was set at an initial temperature of 55° C. and a rotational speed of 65 rpm, the HNBR 2020L was added, and plastication was conducted for 2 min; then the stearic acid, the zinc oxide, the MB, and the RD were added, and first internal mixing was conducted for 3 min; and then the carbon black N220, the spray carbon black N990, and the eco-friendly plasticizing agent TP-95 were added, and second internal mixing was conducted for 5 min to 8 min to obtain a masterbatch.
S2. The masterbatch obtained in the S1 was subjected to third internal mixing with the DCP and the TAIC for 4 min to obtain a HNBR mixture.
S3. The HNBR mixture obtained in the S2 was vulcanized twice to obtain the rubber sealing gasket with excellent compression performance and low-temperature performance, where a first vulcanization was conducted for 20 min in an injection vulcanization machine with a first vulcanization temperature of 170° C. and a vulcanization pressure of 15 MPa; and a second vulcanization was atmospheric pressure layered vulcanization conducted for 4 h in a small drying room with a second vulcanization temperature of 150° C.

### Example 2

A rubber sealing gasket with excellent compression performance and low-temperature performance was provided, and the rubber sealing gasket was prepared from the following raw materials in parts by mass:

HNBR 2020L: 100 parts; stearic acid: 0.9 parts; TAIC: 4.8 parts; vulcanizing agent DCP: 4.8 parts; zinc oxide: 4.8 parts; anti-aging agent MB: 0.9 parts; anti-aging agent RD: 0.9 parts; carbon black N220: 30 parts; spray carbon black N990: 25 parts; and eco-friendly plasticizing agent TP-95: 4.8 parts.

The HNBR 2020L had an acrylonitrile content of 37%, a Mooney viscosity of 60, a specific gravity of 0.95 g/cm³, a hydrogenation rate of 90%, and an iodine index of 28.

A preparation method of the rubber sealing gasket with excellent compression performance and low-temperature performance was the same as the preparation method in Example 1.

### Example 3

A rubber sealing gasket with excellent compression performance and low-temperature performance was provided, and the rubber sealing gasket was prepared from the following raw materials in parts by mass:
HNBR 2020L: 100 parts; stearic acid: 1.1 part; TAIC: 5.2 parts; vulcanizing agent DCP: 5.2 parts; zinc oxide: 5.2 parts; anti-aging agent MB: 1.1 part; anti-aging agent RD: 1.1 part; carbon black N220: 20 parts; spray carbon black N990: 35 parts; and eco-friendly plasticizing agent TP-95: 5.2 parts.

The HNBR 2020L had an acrylonitrile content of 37%, a Mooney viscosity of 60, a specific gravity of 0.95 g/cm³, a hydrogenation rate of 90%, and an iodine index of 28.

A preparation method of the rubber sealing gasket with excellent compression performance and low-temperature performance was the same as the preparation method in Example 1.

### Comparative Example 1

Raw materials for preparing a rubber sealing gasket in this example were the same as those in Example 1, except that HNBR was HNBR 1010L.

### Comparative Example 2

Raw materials for preparing a rubber sealing gasket in this example were the same as those in Example 1, except that HNBR was HNBR 2000L.

### Comparative Example 3

Raw materials for preparing a rubber sealing gasket in this example were the same as those in Example 1, except that HNBR was HNBR 2010L.

### Comparative Example 4

Raw materials for preparing a rubber sealing gasket in this example were the same as those in Example 1, except that HNBR was HNBR 2030L.

The HNBRs in Example 1 and Comparative Examples 1 to 4 each were tested for a Mooney viscosity. Test results are shown in Table 1.

TABLE 1
Mooney viscosity properties of the raw rubbers

Mooney viscosity

| Item | MV.mooney | Max.mooney |
|---|---|---|
| Comparative Example 1 | 60.60 | 109.91 |
| Comparative Example 2 | 68.07 | 107.93 |
| Comparative Example 3 | 85.55 | 132.64 |
| Comparative Example 4 | 58.63 | 86.63 |
| Example 1 | 65.11 | 97.62 |

It can be seen from Table 1 that the HNBRs (raw rubbers) in Comparative Example 4 and Example 1 have small Mooney viscosity values, and exhibit excellent plasticity and fluidity.

The HNBR mixtures prepared in Example 1 and Comparative Examples 1 to 4 each were tested for vulcanization properties at 170° C., where a vulcanization time of a test piece was recorded as t₁₀₀. Results are shown in Table 2.

TABLE 2
Vulcanization properties of the HNBR mixtures

| Item | MH/N · m | ML/N · m | t₁₀ (m:s) | t₉₀ (m:s) | t₁₀₀ (m:s) |
|---|---|---|---|---|---|
| Comparative | 24.63 | 0.91 | 0:43 | 7:19 | 23:50 |
| Example 1 | | | | | |
| Comparative | 24.59 | 1.37 | 0:41 | 7:14 | 21:19 |
| Example 2 | | | | | |
| Comparative | 24.77 | 1.71 | 0:46 | 7:35 | 18:27 |
| Example 3 | | | | | |
| Comparative | 32.57 | 1.16 | 0:36 | 6:50 | 27:54 |
| Example 4 | | | | | |
| Example 1 | 27.81 | 1.27 | 0:42 | 7:21 | 20:02 |

It can be seen from Table 2 that t₁₀₀ values of the HNBR mixtures (raw rubber systems) in Comparative Example 3 and Example 1 are relatively low, indicating a short vulcanization time and a high vulcanization efficiency.

In order to meet the use requirements of rubber sealing gaskets for automobile air-conditioning systems, the rubber sealing gaskets prepared in Example 1 and Comparative Examples 1 to 4 each were subjected to performance tests. Performance requirements of rubber sealing gaskets for automobile air-conditioning systems are shown in Table 3.

TABLE 3
Performance requirements of rubber sealing gaskets for automobile air-conditioning systems

| Property | | Property | | |
|---|---|---|---|---|
| category | Property item | requirement | Standard | Remark |
| Basic | Hardness (Shore A) | 75 ± 5 | ISO 48, Method M | |
| properties | Density (g/cm³) | | ISO 2781 | |
| | Impact elasticity | | GB/T1681 | |
| Mechanical | Elongation at break (%) | ≥150 | ISO 37 | |
| properties | Tensile strength (Mpa) | ≥10 | ISO 37 | |
| | 100% tensile stress at a given elongation (MPa) | ≥2.8 | ISO 37 | |
| Aging | Tensile strength (MPa) | ≥8 | ISO 188, | 72 ± 2 h |
| properties | Change rate of a tensile strength (%) | ≤−20 | Method B | *150° C. ± 3° C. |
| | Change rate of an elongation at break (%) | ≤−30 | | |
| | Change rate of a 100% tensile stress at a given elongation (%) | ≤+30 | | |
| | Hardness (Shore A) change value | ±5 | | |
| | Change rate of a tensile strength (%) | ≤+30 | ISO 188, | 504 ± 2 h |
| | Change rate of an elongation at break (%) | ≤−50 | Method B | *135° C. ± 3° C. |
| | Hardness (Shore A) change value | ±15 | | |
| Low-temperature | Low-temperature brittleness test | No crack | ISO 23529 | 5 ± 1 h |
| performance | | | | *−40° C. ± 3° C. |
| Compression | Compression set test (%) | ≤30 | ISO 815, | 125° C. ± 3° C. 72 ± 2 h, |
| performance | | | GB/T7759 | compression rate: 25%, and |
| | | | | type A sample |
| TGA | TGA test | | ISO 7111 | 50° C. to 950° C. |
| Tg test | DSC test | ° C. | ISO 11357 | Part 2 to midpoint |

According to the performance requirements of rubber sealing gaskets for automobile air-conditioning systems, the rubber sealing gaskets prepared in Example 1 and Comparative Examples 1 to 4 each were tested for basic properties such as hardness, density, and impact elasticity, where at least 5 samples were adopted for each group, and then an average value was taken. Test results are as follows:

TABLE 4
Hardness, density, and impact elasticity
values of the rubber sealing gaskets

| | Vulcanization | Shore A | Density/ | Impact |
|---|---|---|---|---|
| | mode | hardness | (g/cm³) | elasticity/% |
| Comparative | First | 73 | 1.173 | 21 |
| Example 1 | vulcanization | | | |
| Comparative | 170° C. × 20 min | 72 | 1.168 | 35.5 |
| Example 2 | | | | |
| Comparative | | 73 | 1.164 | 36 |
| Example 3 | | | | |
| Comparative | | 73 | 1.162 | 36 |
| Example 4 | | | | |
| Example 1 | | 72 | 1.160 | 34 |
| Comparative | Second | 79 | 1.187 | 16 |
| Example 1 | vulcanization | | | |
| Comparative | 150° C. × 4 h | 75 | 1.161 | 32 |
| Example 2 | | | | |
| Comparative | | 74 | 1.169 | 29 |
| Example 3 | | | | |
| Comparative | | 75 | 1.172 | 29 |
| Example 4 | | | | |
| Example 1 | | 75 | 1.159 | 30 |

It can be seen from Table 4 that the hardness (Shore A, 75±5) and impact elasticity (higher than or equal to 30) of the rubber sealing gaskets obtained after the first vulcanization in Example 1 and Comparative Examples 2, 3, and 4 all meet the performance requirements of rubber sealing gaskets with excellent compression performance and low-temperature performance for automobile air-conditioning systems, while only the hardness (75±5) and impact elasticity (higher than or equal to 30) of the rubber sealing gaskets obtained after the second vulcanization in Example 1 and Comparative Example 2 meet the performance requirements of rubber sealing gaskets with excellent compression performance and low-temperature performance for automobile air-conditioning systems.

According to the performance requirements of rubber sealing gaskets for automobile air-conditioning systems, the rubber sealing gaskets obtained after the first vulcanization and the second vulcanization in Example 1 and Comparative Examples 1 to 4 each were tested for mechanical properties and thermal-oxidative aging properties, where at least 5 samples were adopted for each group, and then an average value was taken. Test results are as follows:

TABLE 5
Comparison of thermal-oxidative aging properties at 150° C. × 72
h of rubber sealing gaskets obtained after the first vulcanization

| | | Comparative | Comparative | Comparative | Comparative | |
|---|---|---|---|---|---|---|
| Item | | Example 1 | Example 2 | Example 3 | Example 4 | Example 1 |
| Before | Tensile strength/MPa | 20.44 | 17.38 | 16.15 | 17.47 | 19.45 |
| aging | Elongation at break/% | 260 | 235 | 219 | 212 | 253 |
| | 100% tensile stress at a | 6.00 | 5.62 | 5.43 | 6.30 | 5.70 |
| | given elongation/MPa | | | | | |
| After | Tensile strength/MPa | 21.66 | 21.32 | 22.77 | 21.73 | 21.65 |
| aging | Elongation/% | 154 | 188 | 214 | 150 | 166 |
| | 100% tensile stress at a | 14.24 | 11.10 | 10.45 | 13.71 | 12.80 |
| | given elongation/MPa | | | | | |
| | Hardness | 85 | 81 | 81 | 82 | 82 |
| Aging | Change rate of a tensile | 6.0 | 23 | 41 | 24 | 11 |
| coefficient | strength/% | | | | | |
| | Change rate of an | −41 | −20 | −2 | −29 | −34 |
| | elongation at break/% | | | | | |
| | Change rate of a 100% | 137 | 98 | 92 | 118 | 125 |
| | tensile stress at a given | | | | | |
| | elongation/% | | | | | |
| | Hardness change value | 12 | 9 | 8 | 9 | 10 |

It can be seen from Table 5 that tensile properties of all rubber sealing gaskets obtained after the first vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but all rubber sealing gaskets obtained after the first vulcanization cannot meet all aging property requirements (a change rate of a tensile strength is lower than or equal to ±20%, a change rate of an elongation at break is lower than or equal to −30, a change rate of a 100% tensile stress at a given elongation is lower than or equal to +30, and a hardness (Shore A) change value is ±5) after thermal-oxidative aging at 150° C.×72 h.

TABLE 6
Comparison of thermal-oxidative aging properties at 150° C. × 72
h of rubber sealing gaskets obtained after the second vulcanization

| | | Comparative | Comparative | Comparative | Comparative | |
|---|---|---|---|---|---|---|
| Item | | Example 1 | Example 2 | Example 3 | Example 4 | Example 1 |
| Before | Tensile strength/MPa | 21.99 | 20.51 | 20.18 | 23.07 | 19.28 |
| aging | Elongation at break/% | 252 | 251 | 276 | 204 | 236 |
| | 100% tensile stress at a | 7.65 | 6.13 | 5.45 | 9.96 | 9.93 |
| | given elongation/MPa | | | | | |
| After | Tensile strength/MPa | 22.30 | 20.93 | 20.68 | 19.70 | 20.72 |
| aging | Elongation/% | 156 | 179 | 191 | 136 | 173 |
| | 100% tensile stress at a | 14.0 | 10.7 | 10.3 | 13.8 | 11.8 |
| | given elongation/MPa | | | | | |
| | Hardness | 85 | 82 | 80 | 83 | 80 |
| Aging | Change rate of a tensile | 1 | 2 | 2 | −15 | 7 |
| coefficient | strength/% | | | | | |
| | Change rate of an | −38 | −29 | −31 | −33 | −27 |
| | elongation at break/% | | | | | |
| | Change rate of a 100% | 83 | 75 | 89 | 39% | 19 |
| | tensile stress at a given | | | | | |
| | elongation/% | | | | | |
| | Hardness change value | 6 | 7 | 6 | 8 | 5 |

It can be seen from Table 6 that tensile properties of all rubber sealing gaskets obtained after the second vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but only Example 1 (2020L is adopted as a raw rubber system) can meet all aging property requirements (a change rate of a tensile strength is lower than or equal to ±20%, a change rate of an elongation at break is lower than or equal to −30, a change rate of a 100% tensile stress at a given elongation is lower than or equal to +30%, and a hardness (Shore A) change value is ±5) after thermal-oxidative aging at 150° C.×72 h.

TABLE 7
Comparison of thermal-oxidative aging properties at 135° C. × 504
h of rubbersealing gaskets obtained after the first vulcanization

| | | Comparative | Comparative | Comparative | Comparative | |
|---|---|---|---|---|---|---|
| Item | | Example 1 | Example 2 | Example 3 | Example 4 | Example 1 |
| Before | Tensile strength/MPa | 20.44 | 17.38 | 16.15 | 17.47 | 19.45 |
| aging | Elongation at break/% | 260 | 235 | 219 | 212 | 253 |
| | 100% tensile stress at a | 6.00 | 5.62 | 5.43 | 6.30 | 5.70 |
| | given elongation/MPa | | | | | |
| After | Tensile strength/MPa | 19.49 | 20.53 | 23.08 | 20.32 | 23.17 |
| aging | Elongation/% | 82 | 139 | 146 | 73 | 121 |
| | 100% tensile stress at a | 16.84 | 14.88 | 16.35 | 14.31 | 19.41 |
| | given elongation/MPa | | | | | |
| | Hardness | 90 | 85 | 85 | 90 | 87 |
| Aging | Change rate of a tensile | −5 | 15 | 43 | 16 | 19 |
| coefficient | strength/% | | | | | |
| | Change rate of an | −68 | −41 | −33 | −66 | −52 |
| | elongation at break/% | | | | | |
| | Hardness change value | 17 | 13 | 12 | 17 | 15 |

It can be seen from Table 7 that tensile properties of all rubber sealing gaskets obtained after the first vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but the rubber sealing gasket in Comparative Example 2 (2000L is adopted as a raw rubber system) can meet all aging property requirements (a change rate of a tensile strength is lower than or equal to ±30%, a change rate of an elongation at break is lower than or equal to −50%, and a hardness (Shore A) change value is ±15) after thermal-oxidative aging at 135° C.×504 h.

TABLE 8
Comparison of thermal-oxidative aging properties at 135° C. × 504
h of rubber sealing gaskets obtained after the second vulcanization

| | | Comparative | Comparative | Comparative | Comparative | |
|---|---|---|---|---|---|---|
| Item | | Example 1 | Example 2 | Example 3 | Example 4 | Example 1 |
| Before | Tensile strength/MPa | 21.99 | 20.51 | 20.18 | 23.07 | 19.28 |
| aging | Elongation at break/% | 252 | 251 | 276 | 204 | 236 |
| | 100% tensile stress at a | 7.65 | 6.13 | 5.45 | 9.96 | 5.93 |
| | given elongation/MPa | | | | | |
| After | Tensile strength/MPa | 23.24 | 21.39 | 24.95 | 17.64 | 19.89 |
| aging | Elongation/% | 101 | 143 | 157 | 64 | 138 |
| | 100% tensile stress at a | 23.02 | 15.54 | 16.67 | 18.83 | 19.30 |
| | given elongation/MPa | | | | | |
| | Hardness | 90 | 84 | 85 | 90 | 87 |
| Aging | Change rate of a tensile | 6 | 4 | 2 | −24 | 3 |
| coefficient | strength/% | | | | | |
| | Change rate of an | −60 | −43 | −43 | −69 | −42 |
| | elongation at break/% | | | | | |
| | Hardness change value | 11 | 9 | 11 | 15 | 12 |

It can be seen from Table 8 that tensile properties of all rubber sealing gaskets obtained after the second vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but only the rubber sealing gaskets of formula 2 #(2000L is adopted as a raw rubber system), formula 3 #(2010L is adopted as a raw rubber system), and formula 4 #(2020L is adopted as a raw rubber system) can meet all aging property requirements (a change rate of a tensile strength is lower than or equal to ±30%, a change rate of an elongation at break is lower than or equal to −50%, and a hardness (Shore A) change value is ±15) after thermal-oxidative aging at 135° C.×504 h.

The rubber sealing gaskets produced after the first vulcanization and the second vulcanization in Example 1 and Comparative Examples 1 to 4 each were subjected to a low-temperature brittleness test. It can be seen that the rubber sealing gaskets produced after the first vulcanization in Example 1 and Comparative Examples 1 to 4 all have a small number of cracks after the low-temperature brittleness test (−40° C.×5 h), which does not meet the low-temperature performance requirements of rubber sealing gaskets with excellent compression performance and low-temperature performance for automobile air-conditioning systems; and the rubber sealing gaskets produced after the second vulcanization in Example 1 and Comparative Examples 1 to 4 do not have cracks and damages after the low-temperature brittleness test (−40° C.×5 h), which meets the low-temperature performance requirements of rubber sealing gaskets with excellent compression performance and low-temperature performance for automobile air-conditioning systems.

According to the performance requirements of rubber sealing gaskets for automobile air-conditioning systems, the rubber sealing gaskets prepared in Example 1 and Comparative Examples 1 to 4 each were tested for compression set performance, where at least 5 samples were adopted for each group, and then an average value was taken. Test results are as follows:

TABLE 9
Compression set performance of the rubber sealing gaskets

| | | Limiter | Height before | Height after | Compression |
|---|---|---|---|---|---|
| | Vulcanization mode | height/mm | compression/mm | compression/mm | set rate/% |
| Comparative Example 1 | First vulcanization | 9.4 | 12.42 | 11.20 | 40 |
| Comparative Example 2 | 170° C. × 20 min | | 12.40 | 11.22 | 39 |
| Comparative Example 3 | | | 12.48 | 11.28 | 39 |
| Comparative Example 4 | | | 12.44 | 11.52 | 30 |
| Example 1 | | | 12.44 | 11.34 | 36 |
| Comparative Example 1 | Second vulcanization | | 12.38 | 11.22 | 39 |
| Comparative Example 2 | 150° C. × 4 h | | 12.36 | 11.28 | 36 |
| Comparative Example 3 | | | 12.40 | 11.36 | 35 |
| Comparative Example 4 | | | 12.40 | 11.68 | 24 |
| Example 1 | | | 12.36 | 11.48 | 30 |

It can be seen from Table 9 that, after the first vulcanization, only the compression set performance (compression rate: 25%, type A sample, 125° C.×72 h) of the rubber sealing gasket produced in Comparative Example 4 (2030L is adopted as a raw rubber system) meets the compression performance requirement (compression set rate: lower than or equal to 30%) of rubber sealing gaskets with excellent compression performance and low-temperature performance for automobile air-conditioning systems; and after the second vulcanization, the compression set performance (compression rate: 25%, type A sample, 125° C.×72 h) of the rubber sealing gaskets produced both in Example 1 (2020L is adopted as a raw rubber system) and Comparative Example 4 (2030L is adopted as a raw rubber system) meets the compression performance requirement (compression set rate: lower than or equal to 30%) of rubber sealing gaskets with excellent compression performance and low-temperature performance for automobile air-conditioning systems.

In summary, it can be seen from test results of plasticity, vulcanization characteristics, basic properties, mechanical properties, aging properties, low-temperature performance, and compression set performance of the rubber sealing gaskets that the rubber sealing gasket produced after the second vulcanization in Example 1 with 2020L as a raw rubber system has prominent comprehensive properties and can meet all performance requirements of rubber sealing gaskets with excellent compression performance and low-temperature performance for automobile air-conditioning systems.

In order to further illustrate the effects of the present disclosure, the present disclosure also sets the following comparative examples, which are specifically as follows:

### Comparative Example 5

Raw materials for preparing a rubber sealing gasket in this comparative example are the same as in Example 1, except that: only 55 parts of carbon black N220 are adopted as the reinforcing filler.

### Comparative Example 6

Raw materials for preparing a rubber sealing gasket in this comparative example are the same as in Example 1, except that: only 55 parts of carbon black N990 are adopted as the reinforcing filler.

### Comparative Example 7

Raw materials for preparing a rubber sealing gasket in this comparative example are the same as in Example 1, except that: only 55 parts of carbon black N330 are adopted as the reinforcing filler.

### Comparative Example 8

Raw materials for preparing a rubber sealing gasket in this comparative example are the same as in Example 1, except that: only 55 parts of carbon black N660 are adopted as the reinforcing filler.

### Comparative Example 9

Raw materials for preparing a rubber sealing gasket in this comparative example are the same as in Example 1, except that: 25 parts of carbon black N330 and 30 parts of carbon black N990 are adopted as the reinforcing filler.

### Comparative Example 10

Raw materials for preparing a rubber sealing gasket in this comparative example are the same as in Example 1, except that: 25 parts of carbon black N660 and 30 parts of carbon black N990 are adopted as the reinforcing filler.

### Comparative Example 11

Raw materials for preparing a rubber sealing gasket in this comparative example are the same as in Example 1, except that: 25 parts of carbon black N220 and 30 parts of carbon black N330 are adopted as the reinforcing filler.

### Comparative Example 12

Raw materials for preparing a rubber sealing gasket in this comparative example are the same as in Example 1, except that: 25 parts of carbon black N220 and 30 parts of carbon black N660 are adopted as the reinforcing filler.

The rubber sealing gaskets prepared in Example 1 and Comparative Examples 5 to 11 were subjected to performance tests below to illustrate the effects of the present disclosure.

The HNBRs in Example 1 and Comparative Examples 5 to 12 each were tested for a Mooney viscosity. Test results are as follows:

TABLE 10
Mooney viscosity performance of rubber mixtures

Mooney viscosity

| Item | MV.mooney | Max.mooney |
|---|---|---|
| Comparative Example 5 | 74.92 | 144.06 |
| Comparative Example 6 | 63.36 | 96.15 |
| Comparative Example 7 | 70.06 | 112.40 |
| Comparative Example 8 | 69.37 | 102.26 |
| Comparative Example 9 | 64.52 | 97.72 |
| Comparative Example 10 | 65.96 | 95.87 |
| Comparative Example 11 | 72.02 | 109.75 |
| Comparative Example 12 | 69.78 | 105.39 |
| Example 1 | 65.11 | 97.62 |

It can be seen from Table 10 that the rubber mixtures in Comparative Example 6 (55 parts of N990 are adopted as the reinforcing filler), Comparative Example 9 (25 parts of N330 and 30 parts of N990 are adopted as the reinforcing filler), Comparative Example 10 (25 parts of N660 and 30 parts of N990 are adopted as the reinforcing filler), and Example 1 (25 parts of N220 and 30 parts of N990 are adopted as the reinforcing filler) have a small Mooney viscosity and excellent plasticity and fluidity.

TABLE 11
Vulcanization properties of rubber mixtures

| | M_{H}/ | M_{L}/ | t₁₀ | t₉₀ | t₁₀₀ |
|---|---|---|---|---|---|
| Item | N · m | N · m | (m:s) | (m:s) | (m:s) |
| Comparative Example 5 | 26.99 | 1.67 | 0:38 | 7:12 | 24:09 |
| Comparative Example 6 | 30.42 | 1.05 | 0:26 | 7:10 | 25:45 |
| Comparative Example 7 | 26.75 | 4.73 | 0:18 | 7:20 | 25:51 |
| Comparative Example 8 | 31.04 | 1.15 | 0:26 | 7:48 | 22:30 |
| Comparative Example 9 | 29.89 | 1.28 | 0:28 | 7:35 | 26:42 |
| Comparative Example 10 | 30.76 | 1.17 | 0:25 | 7:11 | 24:19 |
| Comparative Example 11 | 29.34 | 1.78 | 0:17 | 7:08 | 24:24 |
| Comparative Example 12 | 28.50 | 1.32 | 0:28 | 7:44 | 31:24 |
| Example 1 | 27.81 | 1.27 | 0:42 | 7:21 | 20:02 |

It can be seen from Table 11 that t₁₀₀ of the rubber mixture (25 parts of N220 and 30 parts of N990 are adopted as the reinforcing filler) in Example 1 is relatively low, indicating a short vulcanization time and a high vulcanization efficiency.

TABLE 12
Hardness, density, and impact elasticity
values of the rubber sealing gaskets

| | | | | Impact |
|---|---|---|---|---|
| | Vulcanization | Shore A | Density/ | elastic- |
| | mode | hardness | (g/cm³) | ity/% |
| Comparative Example 5 | First | 75 | 1.160 | 31 |
| Comparative Example 6 | vulcanization | 71 | 1.157 | 37 |
| Comparative Example 7 | 170° C. × | 75 | 1.169 | 32 |
| Comparative Example 8 | 20 min | 73 | 1.162 | 36 |
| Comparative Example 9 | | 74 | 1.163 | 35.5 |
| Comparative Example 10 | | 71 | 1.168 | 36.5 |
| Comparative Example 11 | | 74 | 1.161 | 31 |
| Comparative Example 12 | | 74 | 1.165 | 33 |
| Example 1 | | 73 | 1.162 | 36 |
| Comparative Example 5 | Second | 79 | 1.166 | 27.0 |
| Comparative Example 6 | vulcanization | 75 | 1.173 | 31.5 |
| Comparative Example 7 | 150° C. × | 78 | 1.174 | 28.0 |
| Comparative Example 8 | 4 h | 76 | 1.176 | 28.5 |
| Comparative Example 9 | | 76 | 1.169 | 30.5 |
| Comparative Example 10 | | 74 | 1.176 | 32.0 |
| Comparative Example 11 | | 79 | 1.165 | 27.0 |
| Comparative Example 12 | | 77 | 1.169 | 29.5 |
| Example 1 | | 72 | 1.160 | 34.0 |

It can be seen from Table 12 that the hardness (75±5) and impact elasticity (higher than or equal to 30) of all rubber sealing gasket samples produced after the first vulcanization meet the performance requirements of rubber sealing gaskets with excellent compression performance and low-temperature performance for automobile air-conditioning systems; and the hardness (75±5) and impact elasticity (higher than or equal to 30) of the rubber sealing gasket samples produced after the second vulcanization in Comparative Example 6 (55 parts of N990 are adopted as the reinforcing filler), Comparative Example 9 (25 parts of N330 and 30 parts of N990 are adopted as the reinforcing filler), Comparative Example 10 (25 parts of N660 and 30 parts of N990 are adopted as the reinforcing filler), and Example 1 (25 parts of N220 and 30 parts of N990 are adopted as the reinforcing filler) all meet the performance requirements of rubber sealing gaskets with excellent compression performance and low-temperature performance for automobile air-conditioning systems.

TABLE 13
Comparison of thermal-oxidative aging properties at 150° C. × 72 h of rubber sealing gaskets obtained after the first vulcanization

| | | Compar- | Compar- | Compar- | Compar- | Compar- | Compar- | Compar- | Compar- | |
|---|---|---|---|---|---|---|---|---|---|---|
| | | ative | ative | ative | ative | ative | ative | ative | ative | |
| Item | | Example 5 | Example 6 | Example 7 | Example 8 | Example 9 | Example 10 | Example 11 | Example 12 | Example 1 |
| Before | Tensile | 26.04 | 13.41 | 22.58 | 19.07 | 17.22 | 14.92 | 20.57 | 20.46 | 19.45 |
| aging | strength/MPa | | | | | | | | | |
| | Elongation at | 252 | 208 | 196 | 172 | 199 | 226 | 202 | 198 | 253 |
| | break/% | | | | | | | | | |
| | 100% tensile | 5.28 | 6.14 | 6.50 | 7.59 | 6.67 | 5.71 | 5.68 | 7.02 | 5.70 |
| | stress at | | | | | | | | | |
| | a given | | | | | | | | | |
| | elongation/ | | | | | | | | | |
| | MPa | | | | | | | | | |
| After | Tensile | 29.03 | 17.24 | 22.06 | 27.63 | 19.87 | 16.23 | 25.04 | 25.33 | 21.65 |
| aging | strength/MPa | | | | | | | | | |
| | Elongation/% | 185 | 182 | 149 | 168 | 165 | 140 | 150 | 163 | 166 |
| | 100% tensile | 12.18 | 9.97 | 13.02 | 13.20 | 11.39 | 10.83 | 14.15 | 13.16 | 12.80 |
| | stress at | | | | | | | | | |
| | a given | | | | | | | | | |
| | elongation/ | | | | | | | | | |
| | MPa | | | | | | | | | |
| | Hardness | 85 | 80 | 82 | 85 | 82 | 84 | 85 | 83 | 82 |
| Aging | Change rate | 11 | 29 | −2 | 45 | 15 | 9 | 22 | 24 | 11 |
| coefficient | of a tensile | | | | | | | | | |
| | strength/% | | | | | | | | | |
| | Change rate | −27 | −13 | −24 | −2 | −17 | −38 | −26 | −18 | −34 |
| | of an | | | | | | | | | |
| | elongation | | | | | | | | | |
| | at break/% | | | | | | | | | |
| | Change rate | 131 | 62 | 100 | 74 | 71 | 90 | 149 | 87 | 55 |
| | of a 100% | | | | | | | | | |
| | tensile stress | | | | | | | | | |
| | at a given | | | | | | | | | |
| | elongation/% | | | | | | | | | |
| | Hardness | 10 | 9 | 7 | 12 | 8 | 13 | 11 | 9 | 10 |
| | change value | | | | | | | | | |

It can be seen from Table 13 that tensile properties of all rubber sealing gaskets obtained after the first vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but all rubber sealing gaskets obtained after the first vulcanization cannot meet all aging property requirements (a change rate of a tensile strength is lower than or equal to ±20%, a change rate of an elongation at break is lower than or equal to −30, a change rate of a 100% tensile stress at a given elongation is lower than or equal to +30%, and a hardness (Shore A) change value is ±5) after thermal-oxidative aging at 150° C.×72 h.

TABLE 14
Comparison of thermal-oxidative aging properties at 150° C. × 72 h of rubbersealing gaskets obtained after the second vulcanization

| | | Compar- | Compar- | Compar- | Compar- | Compar- | Compar- | Compar- | Compar- | |
|---|---|---|---|---|---|---|---|---|---|---|
| | | ative | ative | ative | ative | ative | ative | ative | ative | |
| Item | | Example 5 | Example 6 | Example 7 | Example 8 | Example 9 | Example 10 | Example 11 | Example 12 | Example 1 |
| Before | Tensile | 25.69 | 15.63 | 22.67 | 21.94 | 18.01 | 17.12 | 26.49 | 21.96 | 19.28 |
| aging | strength/MPa | | | | | | | | | |
| | Elongation | 243 | 232 | 190 | 187 | 199 | 217 | 225 | 196 | 236 |
| | at break/% | | | | | | | | | |
| | 100% tensile | 5.66 | 6.70 | 7.08 | 8.43 | 7.33 | 6.59 | 6.48 | 7.73 | 8.93 |
| | stress at | | | | | | | | | |
| | a given | | | | | | | | | |
| | elongation/ | | | | | | | | | |
| | MPa | | | | | | | | | |
| After | Tensile | 27.05 | 17.46 | 24.60 | 23.68 | 20.08 | 16.97 | 24.00 | 23.17 | 20.72 |
| aging | strength/MPa | | | | | | | | | |
| | Elongation/% | 184 | 172 | 147 | 150 | 160 | 142 | 161 | 162 | 173 |
| | 100% tensile | 11.71 | 10.38 | 14.39 | 14.91 | 12.36 | 11.58 | 13.74 | 12.93 | 11.8 |
| | stress at | | | | | | | | | |
| | a given | | | | | | | | | |
| | elongation/ | | | | | | | | | |
| | MPa | | | | | | | | | |
| | Hardness | 87 | 80 | 86 | 83 | 83 | 81 | 86 | 84 | 80 |
| Aging | Change rate | 5 | 12 | 9 | 8 | 11 | −1 | −9 | 6 | 7 |
| coefficient | of a tensile | | | | | | | | | |
| | strength/% | | | | | | | | | |
| | Change rate | −24 | −26 | −23 | −20 | −20 | −35 | −28 | −17 | −26.7 |
| | of an | | | | | | | | | |
| | elongation | | | | | | | | | |
| | at break/% | | | | | | | | | |
| | Hardness | 8 | 5 | 8 | 7 | 7 | 7 | 7 | 7 | 5 |
| | change value | | | | | | | | | |

It can be seen from Table 14 that tensile properties of all rubber sealing gasket samples obtained after the second vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but only rubber sealing gasket samples in Comparative Example 6 (55 parts of N990 are adopted as the reinforcing filler) and Example 1 (25 parts of N220 and 30 parts of N990 are adopted as the reinforcing filler) can meet all aging property requirements (a change rate of a tensile strength is lower than or equal to ±20%, a change rate of an elongation at break is lower than or equal to −30, a change rate of a 100% tensile stress at a given elongation is lower than or equal to +30%, and a hardness (Shore A) change value is ±5) after thermal-oxidative aging at 150° C.×72 h.

TABLE 15
Comparison of thermal-oxidative aging properties at 135° C. × 504 h of rubber sealing gaskets obtained after the first vulcanization

| | | Compar- | Compar- | Compar- | Compar- | Compar- | Compar- | Compar- | Compar- | |
|---|---|---|---|---|---|---|---|---|---|---|
| | | ative | ative | ative | ative | ative | ative | ative | ative | |
| Item | | Example 5 | Example 6 | Example 7 | Example 8 | Example 9 | Example 10 | Example 11 | Example 12 | Example 1 |
| Before | Tensile | 26.04 | 13.41 | 22.58 | 19.07 | 17.22 | 14.92 | 20.57 | 20.46 | 19.45 |
| aging | strength/MPa | | | | | | | | | |
| | Elongation | 252 | 208 | 196 | 172 | 199 | 226 | 202 | 198 | 253 |
| | at break/% | | | | | | | | | |
| | 100% tensile | 5.28 | 6.14 | 6.50 | 7.59 | 6.67 | 5.71 | 5.68 | 7.02 | 5.7 |
| | stress at | | | | | | | | | |
| | a given | | | | | | | | | |
| | elongation/ | | | | | | | | | |
| | MPa | | | | | | | | | |
| After | Tensile | 25.27 | 16.68 | 24.84 | 23.04 | 22.16 | 16.90 | 25.22 | 24.69 | 23.17 |
| aging | strength/MPa | | | | | | | | | |
| | Elongation/% | 103 | 120 | 100 | 122 | 117 | 106 | 105 | 120 | 121 |
| | 100% tensile | 24.13 | 14.50 | 24.41 | 19.02 | 18.68 | 15.74 | 23.60 | 19.74 | 19.41 |
| | stress at | | | | | | | | | |
| | a given | | | | | | | | | |
| | elongation/ | | | | | | | | | |
| | MPa | | | | | | | | | |
| | Hardness | 91 | 84 | 90 | 86 | 86 | 84 | 90 | 88 | 90 |
| Aging | Change rate | −3 | 24 | 10 | 21 | 29 | 13 | 23 | 21 | 16 |
| coefficient | of a | | | | | | | | | |
| | tensile | | | | | | | | | |
| | strength/% | | | | | | | | | |
| | Change rate | −59 | −42 | −49 | −29 | −41 | −53 | −48 | −39 | −52 |
| | of an | | | | | | | | | |
| | elongation | | | | | | | | | |
| | at break/% | | | | | | | | | |
| | Hardness | 16 | 13 | 15 | 13 | 12 | 13 | 16 | 14 | 15 |
| | change value | | | | | | | | | |

It can be seen from Table 15 that tensile properties of all rubber sealing gasket samples obtained after the first vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but except that the rubber sealing gaskets in Comparative Examples 5 and 11 cannot meet all aging property requirements (a change rate of a tensile strength is lower than or equal to ±30%, a change rate of an elongation at break is lower than or equal to −50%, and a hardness (Shore A) change value is ±15) after thermal-oxidative aging at 135° C.×504 h, other 7 formulas all can meet the aging property requirements.

TABLE 16
Comparison of thermal-oxidative aging properties at 135° C. × 504 h of rubber sealing gaskets obtained after the second vulcanization

| | | Compar- | Compar- | Compar- | Compar- | Compar- | Compar- | Compar- | Compar- | |
|---|---|---|---|---|---|---|---|---|---|---|
| | | ative | ative | ative | ative | ative | ative | ative | ative | |
| Item | | Example 5 | Example 6 | Example 7 | Example 8 | Example 9 | Example 10 | Example 11 | Example 12 | Example 1 |
| Before | Tensile | 25.69 | 15.63 | 22.67 | 21.94 | 18.01 | 17.12 | 26.49 | 21.96 | 19.28 |
| aging | strength/MPa | | | | | | | | | |
| | Elongation | 24 | 232 | 190 | 187 | 199 | 217 | 225 | 196 | 236 |
| | at break/% | | | | | | | | | |
| | 100% tensile | 5.66 | 6.70 | 7.08 | 8.43 | 7.33 | 6.59 | 6.48 | 7.73 | 5.93 |
| | stress at | | | | | | | | | |
| | a given | | | | | | | | | |
| | elongation/ | | | | | | | | | |
| | MPa | | | | | | | | | |
| After | Tensile | 25.41 | 15.76 | 25.38 | 23.72 | 20.00 | 17.95 | 26.44 | 22.29 | 19.89 |
| aging | strength/MPa | | | | | | | | | |
| | Elongation/% | 110 | 113 | 101 | 126 | 112 | 118 | 111 | 105 | 138 |
| | 100% tensile | 22.67 | 14.33 | 25.22 | 19.41 | 18.06 | 15.53 | 22.67 | 21.18 | 19.30 |
| | stress at | | | | | | | | | |
| | a given | | | | | | | | | |
| | elongation/ | | | | | | | | | |
| | MPa | | | | | | | | | |
| | Hardness | 91 | 84 | 90 | 85 | 87 | 85 | 90 | 89 | 87 |
| Aging | Change rate | −1 | 0 | 12 | 8 | 11 | 5 | 0 | 2 | 3 |
| coefficient | of a | | | | | | | | | |
| | tensile | | | | | | | | | |
| | strength/% | | | | | | | | | |
| | Change rate | 55 | 51 | 47 | 33 | 44 | 46 | 51 | 46 | −42 |
| | of an | | | | | | | | | |
| | elongation | | | | | | | | | |
| | at break/% | | | | | | | | | |
| | Hardness | 12 | 9 | 12 | 9 | 11 | 11 | 11 | 12 | 12 |
| | change value | | | | | | | | | |

It can be seen from Table 16 that tensile properties of all rubber sealing gasket samples obtained after the second vulcanization meet the tensile strength requirement (higher than or equal to 10 MPa), elongation at break requirement (higher than or equal to 150%), and 100% tensile stress at a given elongation requirement (higher than or equal to 2.8 MPa) of rubber sealing gaskets with excellent compression performance and low-temperature performance for automobile air-conditioning systems, but except that the rubber sealing gaskets in Comparative Examples 5, 6, and 11 cannot meet all aging property requirements (a change rate of a tensile strength is lower than or equal to 30%, a change rate of an elongation at break is lower than or equal to −50%, and a hardness (Shore A) change value is ±15) after thermal-oxidative aging at 135° C.×504 h, other 6 formulas all can meet the aging property requirements.

The rubber sealing gaskets produced after the first vulcanization and the second vulcanization in Example 1 and Comparative Examples 5 to 12 each were subjected to a low-temperature brittleness test. It can be seen that the rubber sealing gaskets produced after the first vulcanization in Example 1 and Comparative Examples 5 to 12 all have a small number of cracks after the low-temperature brittleness test (−40° C.×5 h), which does not meet the low-temperature performance requirements of rubber sealing gaskets with excellent compression performance and low-temperature performance for automobile air-conditioning systems; and the rubber sealing gaskets produced after the second vulcanization in Example 1 and Comparative Examples 5 to 12 do not have cracks and damages after the low-temperature brittleness test (−40° C.×5 h), which meets the low-temperature performance requirements of rubber sealing gaskets with excellent compression performance and low-temperature performance for automobile air-conditioning systems.

According to the performance requirements of rubber sealing gaskets for automobile air-conditioning systems, the rubber sealing gaskets prepared in Example 1 and Comparative Examples 5 to 12 each were tested for compression set performance, where at least 5 samples were adopted for each group, and then an average value was taken. Test results are as follows:

TABLE 17
Compression set performance of the rubber sealing gaskets

| | Vulcanization | Limiter | Height before | Height after | Compression |
|---|---|---|---|---|---|
| | mode | height/mm | compression/mm | compression/mm | set rate/% |
| Comparative Example 5 | First | 9.4 | 12.52 | 11.08 | 46 |
| Comparative Example 6 | vulcanization | | 12.46 | 11.58 | 29 |
| Comparative Example 7 | 170° C. × 20 min | | 12.44 | 11.36 | 36 |
| Comparative Example 8 | | | 12.44 | 11.78 | 22 |
| Comparative Example 9 | | | 12.54 | 11.54 | 32 |
| Comparative Example 10 | | | 12.54 | 11.70 | 27 |
| Comparative Example 11 | | | 12.44 | 11.22 | 40 |
| Comparative Example 12 | | | 12.56 | 11.60 | 30 |
| Example 1 | | | 12.44 | 11.52 | 30 |
| Comparative Example 5 | Second | | 12.40 | 11.22 | 39 |
| Comparative Example 6 | vulcanization | | 12.40 | 11.78 | 21 |
| Comparative Example 7 | 150° C. × 4 h | | 12.48 | 11.68 | 26 |
| Comparative Example 8 | | | 12.42 | 11.80 | 21 |
| Comparative Example 9 | | | 12.36 | 11.58 | 26 |
| Comparative Example 10 | | | 12.48 | 11.62 | 28 |
| Comparative Example 11 | | | 12.46 | 11.66 | 26 |
| Comparative Example 12 | | | 12.50 | 11.78 | 23 |
| Example 1 | | | 12.40 | 11.68 | 24 |

It can be seen from Table 17 that, after the first vulcanization, the compression set performance (compression rate: 25%, type A sample, 125° C.×72 h) of the rubber sealing gaskets produced in Comparative Examples 6, 8, 10, and 12 and Example 1 all meets the compression performance requirement (compression set rate: lower than or equal to 30%) of rubber sealing gaskets with excellent compression performance and low-temperature performance for automobile air-conditioning systems; and after the second vulcanization, the compression set performance (compression rate: 25%, type A sample, 125° C.×72 h) of the rubber sealing gaskets produced in Comparative Examples 6 to 12 and Example 1 all meets the compression performance requirement (compression set rate: lower than or equal to 30%) of rubber sealing gaskets with excellent compression performance and low-temperature performance for automobile air-conditioning systems.

In summary, it can be seen from test results of plasticity, vulcanization characteristics, basic properties, mechanical properties, aging properties, low-temperature performance, and compression set performance of the rubber sealing gaskets that the rubber sealing gasket produced after the second vulcanization in Example 1 (25 parts of N220 and 30 parts of N990 are adopted as the reinforcing filler) of the present disclosure has prominent comprehensive properties and can meet all performance requirements of rubber sealing gaskets with excellent compression performance and low-temperature performance for automobile air-conditioning systems.

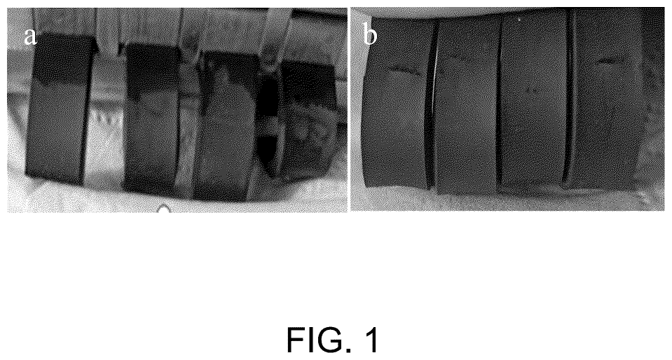

FIG. 1 shows the low-temperature performance of the rubber sealing gasket prepared in Example 1 of the present disclosure, where a is for the rubber sealing gasket after the second vulcanization and b is for the rubber sealing gasket after the first vulcanization. It can be seen from a of FIG. 1 that there are no cracks in the four rubber sealing gasket samples produced after the second vulcanization, and there are cracks in the four rubber sealing gasket samples produced after the first vulcanization to varying degrees. It can be seen from left to right in b of FIG. 1 that there is a 30 mm crack in a first sample, three needle-like cracks in a second sample, two needle-like cracks in a third sample, and one 25 mm crack and one needle-like crack in a fourth sample. It can be seen that the rubber sealing gasket produced merely after the first vulcanization has poor low-temperature performance and cannot meet the performance requirements of rubber sealing gaskets for automobile air-conditioning systems.

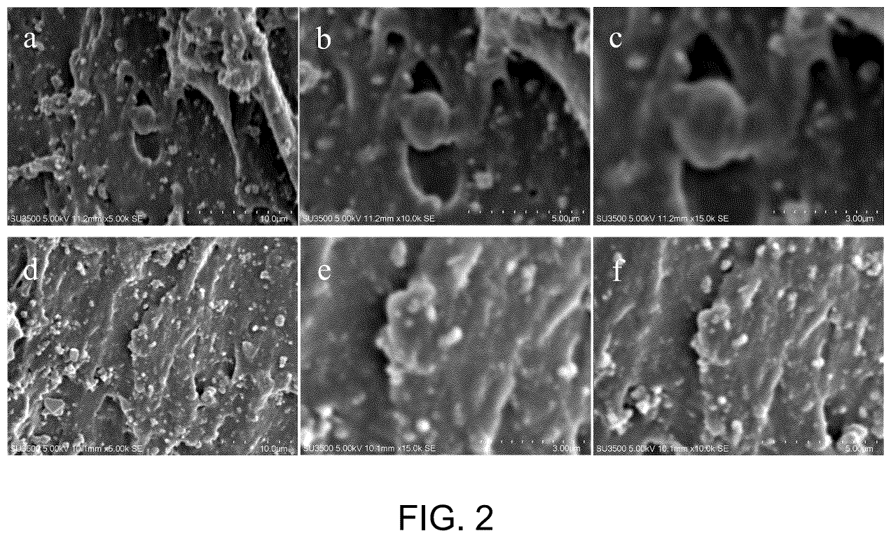

FIG. 2 shows a microstructure (scanning electron microscopy (SEM)) of the rubber sealing gasket prepared in Example 1 of the present disclosure, where a, b, and c show images of the rubber sealing gasket produced after the second vulcanization at magnifications of 15,000, 10,000, and 15,000, respectively; and d, e, and f show images of the rubber sealing gasket produced after the first vulcanization at magnifications of 15,000, 10,000, and 15,000, respectively. It can be seen from FIG. 2 that the rubber sealing gasket produced after the second vulcanization has a smooth surface, indicating that the rubber sealing gasket achieves sufficient fluidity and has an improved crosslinking degree, which can improve the compression performance and mechanical properties of the rubber sealing gasket.

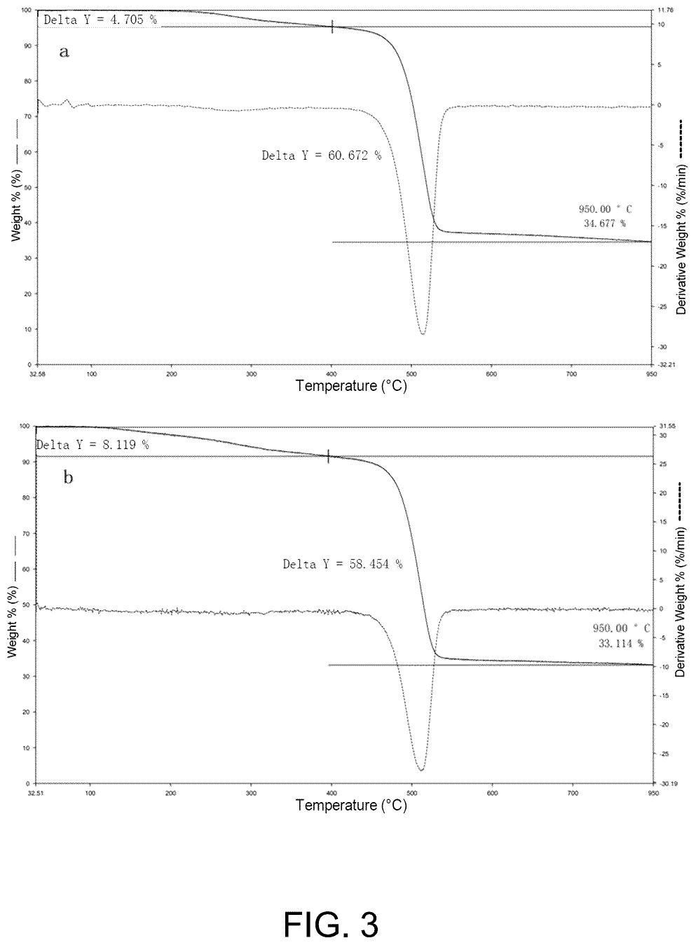

FIG. 3 shows TGA results of the rubber sealing gasket prepared in Example 1 of the present disclosure, where a shows a TGA curve of the rubber sealing gasket produced after the second vulcanization and b shows a TGA curve of the rubber sealing gasket produced after the first vulcanization. A solid line in FIG. 3 shows a mass change percentage of the material in a high-temperature test, and a dotted line shows a weight loss rate of the material with a temperature change in the test. It can be seen from FIG. 3 that, after high-temperature degradation, a mass percentage of the material produced after the second vulcanization is higher than a mass percentage of the material produced after the first vulcanization, indicating that a mass retention rate of the rubber sealing gasket produced after the second vulcanization is better than a mass retention rate of the rubber sealing gasket produced after the first vulcanization. This is because the second vulcanization increases a crosslinking density of the material, enhances a deformation limitation ability of the material, delays the thermal decomposition of the material, and enhances the thermal stability of the material.

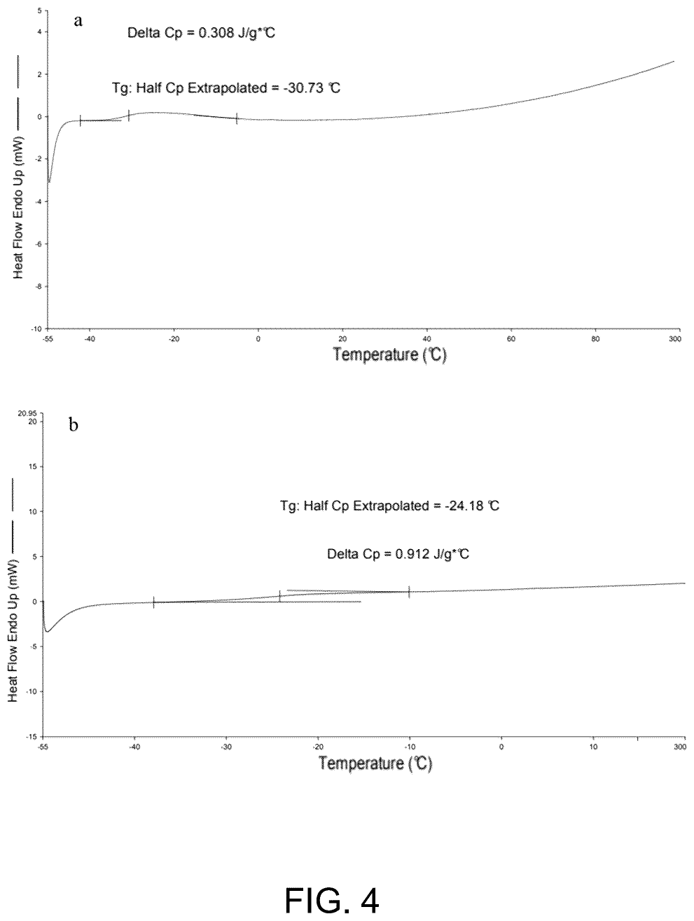

FIG. 4 shows DSC results of the rubber sealing gasket prepared in Example 1 of the present disclosure, where a shows a DSC curve of the rubber sealing gasket produced after the second vulcanization and b shows a DSC curve of the rubber sealing gasket produced after the first vulcanization. It can be seen from FIG. 4 that a glass transition temperature (Tg) of the rubber sealing gasket produced after the second vulcanization is 6.55° C. lower than a glass transition temperature (Tg) of the rubber sealing gasket produced after the first vulcanization, indicating that the low-temperature resistance of the rubber sealing gasket produced after the second vulcanization is better than the low-temperature resistance of the rubber sealing gasket produced after the first vulcanization.

It should be noted that, when a value range is mentioned in the present disclosure, any value within this value range is possible. In order to prevent repetition, the present disclosure merely describes preferred examples, but once those skilled in the art learn the basic creative concept, then these examples can be changed and modified additionally. Therefore, the appended claims are intended to be interpreted as including the preferred examples and all alterations and modifications falling within the scope of the present disclosure.

Obviously, those skilled in the art can make various alterations and modifications to the present disclosure without departing from the spirit and scope of the present disclosure. Thus, provided that these alterations and modifications of the present disclosure fall within the scope of the claims of the present disclosure and their equivalents, the present disclosure is also intended to include these alterations and modifications.

What is claimed is:

1. A rubber sealing gasket with excellent compression performance and low-temperature performance, characterized in that the rubber sealing gasket is prepared from the following raw materials in parts by mass:

| | |
|---|---|
| hydrogenated nitrile butadiene rubber | 100 parts; |
| processing aid | 12.3 parts to 13.7 parts; |
| reinforcing filler | 45 parts to 65 parts; |
| vulcanizing agent | 4.8 parts to 5.2 parts; and |
| co-crosslinking agent | 4.8 parts to 5.2 parts. |

2. The rubber sealing gasket with excellent compression performance and low-temperature performance according to claim 1, characterized in that the hydrogenated nitrile butadiene rubber is hydrogenated nitrile butadiene rubber 2020L with an acrylonitrile content of 36% to 38%, a Mooney viscosity of 50 to 65, a specific gravity of 0.94 g/cm³ to 0.96 g/cm³, a hydrogenation rate of 90% to 91%, and an iodine index of 27 to 28.

3. The rubber sealing gasket with excellent compression performance and low-temperature performance according to claim 2, characterized in that the processing aid is a mixture of an activating agent, an anti-aging agent, and a plasticizing agent, wherein the activating agent comprises zinc oxide and stearic acid, the anti-aging agent comprises anti-aging agents MB and RD, and the plasticizing agent is TP-95.

4. The rubber sealing gasket with excellent compression performance and low-temperature performance according to claim 3, characterized in that the reinforcing filler is a mixture of carbon black N220 and carbon black N990.

5. The rubber sealing gasket with excellent compression performance and low-temperature performance according to claim 4, characterized in that the vulcanizing agent is dicumyl peroxide (DCP), and the co-crosslinking agent is triallyl isocyanurate (TAIC).

6. The rubber sealing gasket with excellent compression performance and low-temperature performance according to claim 5, characterized in that based on 100 parts by mass of the hydrogenated nitrile butadiene rubber, the stearic acid is used in 0.9 parts to 1.1 parts, the zinc oxide is used in 4.8 parts to 5.2 parts, the anti-aging agent MB is used in 0.9 parts to 1.1 parts, the anti-aging agent RD is used in 0.9 parts to 1.1 parts, the plasticizing agent TP-95 is used in 4.8 parts to 5.2 parts, the carbon black N220 is used in 20 parts to 30 parts, the carbon black N990 is used in 25 parts to 35 parts, the dicumyl peroxide is used in 4.8 parts to 5.2 parts, and the triallyl isocyanurate is used in 4.8 parts to 5.2 parts.

7. A preparation method of the rubber sealing gasket with excellent compression performance and low-temperature performance according to claim 1, characterized by comprising the following steps:
S1. subjecting the hydrogenated nitrile butadiene rubber, the processing aid, and the reinforcing filler to first internal mixing to obtain a masterbatch;
S2. subjecting the masterbatch obtained in the S1 to second internal mixing with the vulcanizing agent and the co-crosslinking agent to obtain a hydrogenated nitrile butadiene rubber mixture; and
S3. vulcanizing the hydrogenated nitrile butadiene rubber mixture obtained in the S2 twice to obtain the rubber sealing gasket with excellent compression performance and low-temperature performance.

8. The preparation method of the rubber sealing gasket with excellent compression performance and low-temperature performance according to claim 7, characterized in that in the S3, the vulcanizing is conducted twice as follows: conducting a first vulcanization for 12 min to 22 min at a first temperature of 170° C. to 175° C. and a pressure of 10 MPa to 20 MPa; and conducting a second vulcanization for 3 h to 5 h at a second temperature of 150° C. to 155° C.

9. The preparation method of the rubber sealing gasket with excellent compression performance and low-temperature performance according to claim 8, characterized in that the first vulcanization is conducted by a plate vulcanizing machine or an injection vulcanizing machine, and the second vulcanization is conducted by an atmospheric pressure layered vulcanization process, an atmospheric pressure hot-air vulcanization process, or an atmospheric pressure salt-bath hot vulcanization process.

10. A use of the rubber sealing gasket with excellent compression performance and low-temperature performance according to claim 1 in a sealing component of an automobile air-conditioning system.
